(19) United States
(12) Patent Application Publication
(10) Pub. No.: US 2011/0177893 A1
(43) Pub. Date: Jul. 21, 2011

(54) TABLE TENNIS TABLE TOP

(75) Inventor: Adam Abramson, Oxford, NJ (US)

(73) Assignee: SPORTCRAFT, LTD., Mt. Olive, NJ (US)

(21) Appl. No.: 12/783,030

(22) Filed: May 19, 2010

Related U.S. Application Data
(60) Provisional application No. 61/295,583, filed on Jan. 15, 2010.

(51) Int. Cl. A63B 67/04; B23P 17/04

(52) U.S. Cl. 473/496; 29/428

(57) ABSTRACT

A removable top for a table tennis game has a first side made up of a first and second panel and a second side made up of a third and a fourth panel. Preferably, the first and second panels are hingedly connected to one another and the third and fourth panels are hingedly connected to one another to facilitate ease of assembly and disassembly. A connector beam is placed between the first and second sides for joining the sides together. The connector beam preferably has a length approximately equal to a width of the table top. A pad is affixed to the bottom surface of each panel to protect the table or other structure onto which the table top is set. A net is provided with net posts. A first and second net post may be clamped to ends of the connector beam to install the net.

### CROSS REFERENCE TO RELATED APPLICATIONS

This application claims the priority of U.S. Provisional Patent Application No. 61/295,583 entitled “TABLE TENNIS TABLE TOP,” filed Jan. 15, 2010, the contents of which are hereby incorporated by reference.

### FIELD OF THE INVENTION

The invention relates generally to table tennis tables. In particular, the invention relates to a table tennis top that can be easily located on and removed from an existing table or structure.

### BACKGROUND OF THE INVENTION

Table tennis is a popular indoor game that is played with two or four players, each having a paddle or racquet. The players endeavor to hit a ball back and forth to each other on a table, in a manner similar to tennis. The rules are slightly different, but the concept is very similar. Ball spin, speed, placement, strategy and tactics play an important part in competitive table tennis matches.

A standard table tennis table is 274 cm×152.5 cm×76 cm high (9 ft×5 ft×30 inches high). Because such a table takes up considerable space, table tennis tables for home use are typically of a fold-up design. However, prior art foldable table tennis tables have a number of deficiencies that have detracted from their desirability. Many of the prior art foldable table tennis tables have a complex structure that is expensive to fabricate and may be difficult to assemble. Such prior art tables typically must be shipped in large, bulky containers which take up substantial space in storage and in transit thereby increasing the shipping costs. For example, some of the prior art foldable table tennis tables such as those disclosed in U.S. Pat. No. 3,342,149 to Kruissink, U.S. Pat. No. 3,318,269 to Kinn, and U.S. Pat. No. 2,901,304 to Fihe disclose foldable table tennis tables having a relatively complex welded wheel support unit that is both expensive to fabricate and difficult to package and ship to a customer. Additionally, prior art foldable table tennis tables of the type disclosed in U.S. Pat. No. 5,816,957 to Dadbeh have a relatively complex structure with a wide wheel base, which makes the table expensive to manufacture and difficult to store in confined spaces.

Accordingly, it would be desirable to provide a table tennis table that is relatively inexpensive to fabricate, easily packaged and shipped in a compact, minimally sized package. The table should be easily assembled by the customer by hand without the need of any tools. The table should be easily set up and taken down. And the table should be capable of being stored in a relatively compact arrangement that takes up a minimal amount of space.

### SUMMARY OF THE INVENTION

A removable top for a table tennis game is described herein. The table top has a first side having a first panel adjacent to a second panel, the first panel and the second panel having a baseline side and a net side. A second side of the table top has a third panel adjacent to a fourth panel, the third panel and the fourth panel having a baseline side and a net side.

When placed adjacent to one another, the first panel and the second panel define a first longitudinal seam therebetween. Similarly, the third panel and the fourth panel define a second longitudinal seam therebetween when placed adjacent to one another.

A connector beam is provided that preferably has a cross sectional shape of an I-beam. The connector beam has a first side and a second side. The first side of the connector beam is for receiving the net side of the first panel and the second panel of the first side. The second side of the connector beam for receiving the net side of the third panel and the fourth panel of the second side. The connector beam spans across the first longitudinal seam and the second longitudinal seam when the connector beam receives the first panel and the second panel on the first side of the connector beam and when the connector beam receives the third panel and the fourth panel on the second side of the connector beam. The connector beam preferably has a length that is a few inches shorter than a width of the table when the first panel and the second panel are placed adjacent to one another.

In a preferred embodiment, the first panel and the second panel are hingedly connected to one another and the third panel and the fourth panel are hingedly connected to one another. In one embodiment, the hinged connections are facilitated by a plurality of metal hinges, although other hinged connections are also possible.

The first panel, the second panel, the third panel and the fourth panel have a top surface and a bottom surface. A pad may be affixed to the bottom surface of each of the first panel, the second panel, the third panel and the fourth panel to protect the table or other structure onto which the table top is set.

A first net post is affixed to a first clamp for removably affixing to a side of the table adjacent to the first end of the connector beam. A second net post is affixed to a second clamp for removably affixing a side of the table adjacent to the second end of the connector beam. A first end of a net is affixed to the first net post and a second end of a net is affixed to the second net post.

### BRIEF DESCRIPTION OF THE DRAWINGS

FIG. I is a perspective view of the table tennis table top of the invention shown separated from a supporting table structure, which is shown in phantom lines.

FIG. 2 shows a perspective exploded view wherein the first side and second side are not engaged with the connector beam.

FIG. 3 is a perspective view showing a first side and a second side being inserted into a connector beam.

FIG. 4 is a perspective view of a bottom surface of the first side showing the hinged connection between the first panel and the second panel and also showing protective pads.

FIG. 5A shows a first net post and clamp while installing the net.

FIG. 5B is a perspective view of the first net post and clamp with net installed.

### DETAILED DESCRIPTION OF THE PREFERRED EMBODIMENTS

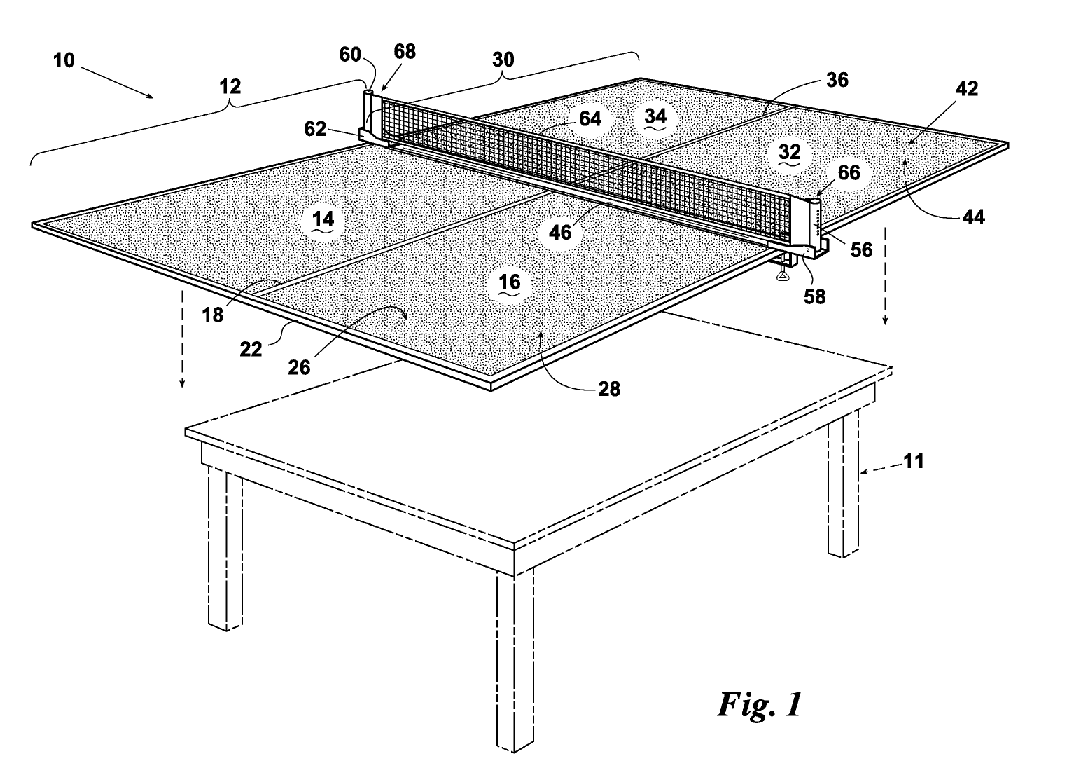

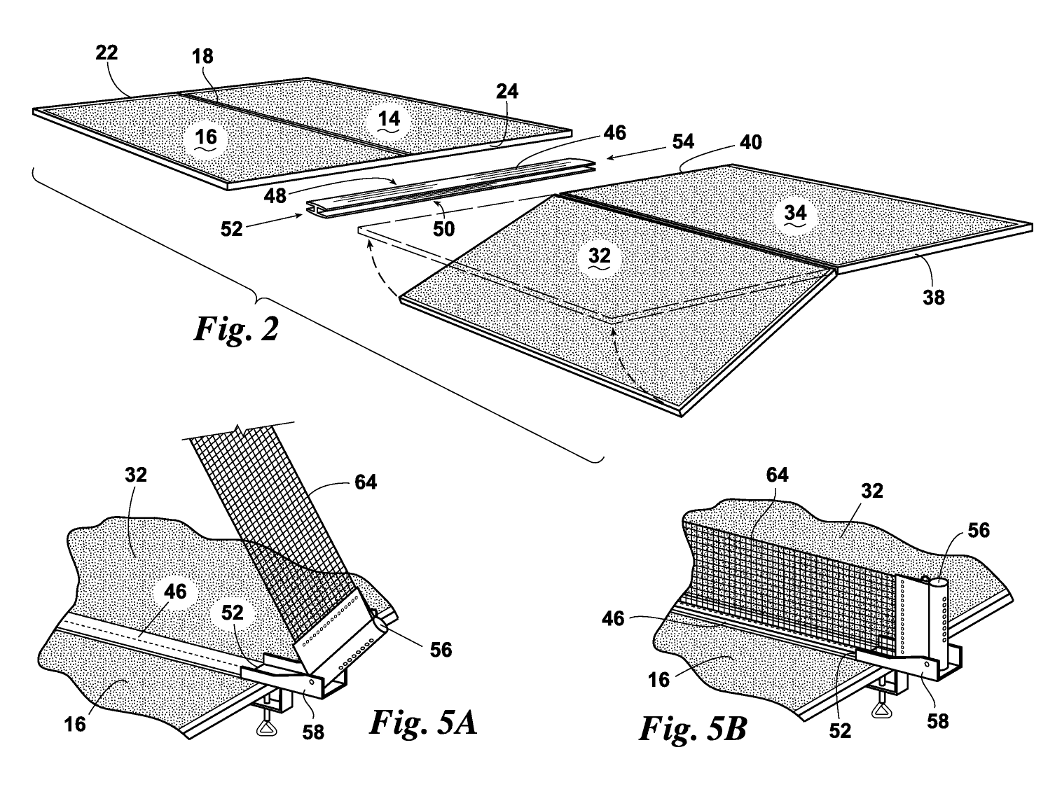

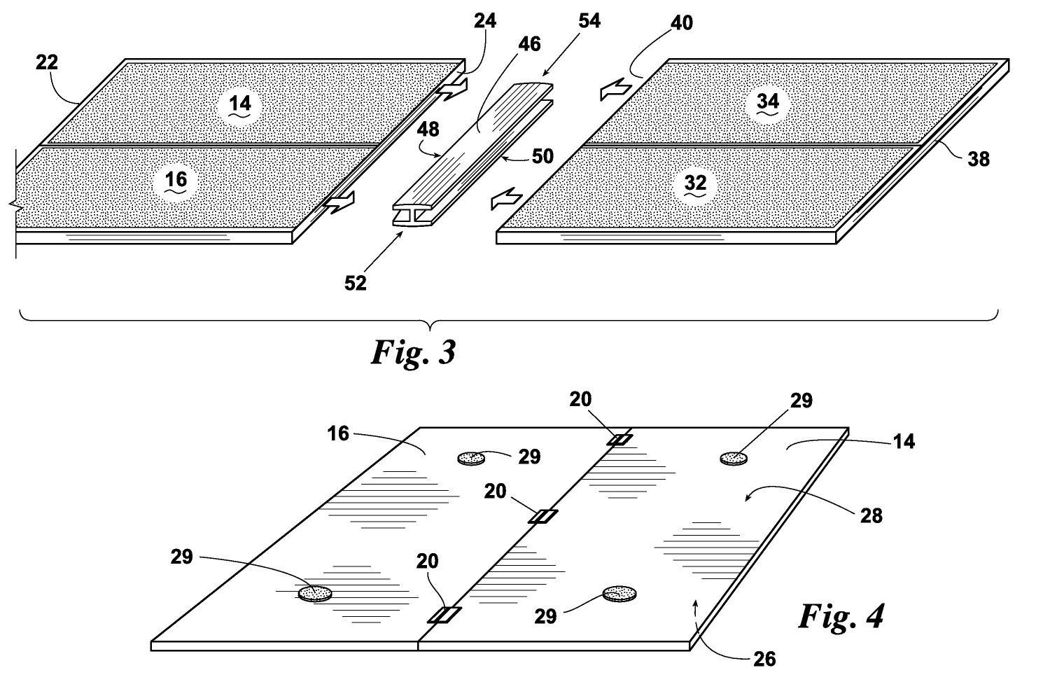

Referring now generally to FIGS. 1-5B, shown is a removable top for a table tennis game, designated generally 10. Removable top 10 may be placed upon any suitable structure, such as conventional table 11, shown in phantom in FIG. 1. Removable top 10 includes a first side 12, having a first panel 14 and a second panel 16. First panel 14 and second panel 16 define a first longitudinal seam 18 therebetween when first panel 14 and second panel 16 are placed adjacent to one another. In a preferred embodiment, first panel 14 and second panel 16 are connected to one another by a plurality of hinges 20 (FIG. 4). First panel 14 and second panel 16 each have a baseline end 22 and a net end 24. Additionally, first panel 14 and second panel 16 have a top surface 26 and a bottom surface 28 (FIGS. 1, 4).

Removable top 10 additionally has a second side 30 (FIG. 1). Second side 30 has a third panel 32 and a fourth panel 34. Third panel 32 and fourth panel 34 define a second longitudinal seam 36 when third panel 32 is placed adjacent to fourth panel 34. In a preferred embodiment, third panel 32 and fourth panel 34 are connected together with a plurality of hinges similar to hinges 20 (FIG. 4). Third panel 32 and fourth panel 34 each have a baseline end 38 and a net end 40. Additionally, third panel 32 and fourth panel 34 have a top surface 42 and a bottom surface 44.

In a preferred embodiment, protective pads 29 (FIG. 4) are affixed to bottom surfaces 28 (FIGS. 4) and 44. Protective pads 29 provide protection to an upper surface of a support structure, such as conventional table 11 (FIG. 1).

A connector beam 46 is provided for facilitating the connection of first side 12 and second side 30 of removable top 10. Connector beam 46 preferably has a cross-sectional shape of an I-beam. Connector beam 46 has a first side 48 and a second side 50. First side 48 of connector beam 46 is sized to receive net end 24 of first panel 14 and second panel 16. Second side 50 of connector beam 46 is sized to receive net end 40 of third panel 32 and fourth panel 34. Preferably, connector beam 46 spans across first longitudinal seam 18 and second longitudinal seam 36 when connector beam 46 receives first panel 14 and second panel 16 on first side 48 of connector beam 46, and also when connector beam 46 receives third panel 32 and fourth panel 34 on second side 50 of connector beam 46. Additionally, it is preferred that connector beam 46 have a length that is several inches shorter than the width of removable top 10, i.e., a length slightly shorter than the width of the first panel 14 and second panel 16 when first panel 14 and second panel 16 are placed adjacent to one another. However, shorter or longer lengths of connector beam 46 are also possible. Connector beam 46 has a first end 52 and a second end 54.

Referring now to FIGS. 1, 5A, and 5B, shown is a first net post 56. First net post 56 is affixed to first clamp 58. Second net post 60 is affixed to second clamp 62. Net 64 has a first end 66 and a second end 68. First end 66 engages first net post 56. Second end 68 of net 64 engages second net post 60. Preferably, first clamp 58 engages a side of table top 10 and has an inside end that abuts first end 52 of connector beam 46. Second clamp 62 preferably engages a second side of table top 10 and has an inside end that abuts second end 54 of connector beam 46. However, in another embodiment, first clamp 58 and second clamp 62 could be secured to ends 52 and 54 of connector beam 46.

Therefore, the removable table top 10 of the invention provides table tennis equipment that is inexpensive to fabricate, primarily due to the replacement of typical supporting structure with a user's existing structure, e.g., a table. The table top of the invention may be easily packaged and stored, since the table top is easily separated into first side 12 and second side 30, each of which may be folded about a hinged connection, resulting in two folded panels of quarter-table dimensions. The connector beam 46 ensures a uniform joining of first side 12 and second 30 and further ensures that hingedly connected panels 14 and 16 and panels 32 and 34 are oriented in a completely flat configuration.

Thus, the present invention is well adapted to carry out the objectives and attain the ends and advantages mentioned above as well as those inherent therein. While presently preferred embodiments have been described for purposes of this disclosure, numerous changes and modifications will be apparent to those of ordinary skill in the art. Such changes and modifications are encompassed within the spirit of this invention as defined by the claims.

What is claimed is:

1. A removable top for a table tennis game comprising:
a first side having a first panel adjacent to a second panel, said first panel and said second panel having a baseline side and a net side;
a second side having a third panel adjacent to a fourth panel, said third panel and said fourth panel having a baseline side and a net side; and
a connector beam having a first side and a second side, said first side of said connector beam for receiving said net side of said first panel and said second panel, said second side of said connector beam for receiving said net side of said third panel and said fourth panel.

2. The removable top according to claim 1 wherein:
said first panel and said second panel are hingedly connected to one another; and
said third panel and said fourth panel are hingedly connected to one another.

3. The removable top according to claim 2 wherein:
said hinged connection between said first panel and said second panel is comprised of a metal hinge; and
said hinged connection between said third panel and said fourth panel is comprised of a metal hinge.

4. The removable top according to claim 1 wherein:
said connector beam has a cross sectional shape of an I-beam.

5. The removable top according to claim 1 wherein:
said first panel and said second panel define a first longitudinal seam therebetween;
said third panel and said fourth panel define a second longitudinal seam therebetween; and
said connector beam spans across said first longitudinal seam and said second longitudinal seam when said connector beam receives said first panel and said second panel on said first side of said connector beam and when said connector beam receives said third panel and said fourth panel on said second side of said connector beam.

6. The removable top according to claim 5 wherein:
said connector beam has a length approximately equal to a width of said first side when said first panel and said second panel are placed adjacent to one another.

7. The removable top according to claim 1 wherein:
said first panel, said second panel, said third panel and said fourth panel have a top surface and a bottom surface; and further comprising
a pad affixed to said bottom surface of each of said first panel, said second panel, said third panel and said fourth panel.

8. The removable top according to claim 1 further comprising:
a first net post affixed to a first clamp for removably affixing to at least one of said first panel and said third panel adjacent to a first end of said connector beam;
a second net post affixed to a second clamp for removably affixing to at least one of the second panel and the fourth panel adjacent to a second end of said connector beam; and
a net having a first end affixed to said first net post and having a second end affixed to said second net post.

9. A method of preparing a table tennis game table comprising the steps of:
placing a first side and second side of a removable top on an existing support structure;
locating a net end of said first side and a net end of said second side into opposite sides of a connector beam; and
affixing a net to at least one of said first side and said second side adjacent to said connector beam.

10. The method according to claim 9 further comprising the steps of:
unfolding a first panel and a second panel about a hinged connection to form said first side.

11. The method according to claim 9 further comprising the steps of:
unfolding a third panel and a fourth panel about a hinged connector to form said second side.

12. A connector beam for assembling a table tennis playing surface comprising:
an elongate member having a cross-section having a shape approximating an I-beam, said elongate member defining a first longitudinal receptacle and a second longitudinal receptacle;
wherein said first longitudinal receptacle and said second longitudinal receptacle are sized to engage an edge of a playing surface panel.
